(19) United States
(12) Patent Application Publication
(10) Pub. No.: US 2025/0227781 A1
(43) Pub. Date: Jul. 10, 2025

(54) METHODS FOR CREATING PIN, COMMUNICATION DEVICES AND STORAGE MEDIA

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/851,492

(22) PCT Filed: Mar. 29, 2022
(86) PCT No.: PCT/CN2022/083806

§ 371 Date: Sep. 26, 2024

(51) Int. Cl. G16Y 30/10; H04W 76/11

(52) U.S. Cl. CPC H04W 76/11; G16Y 30/10

(57) ABSTRACT

Embodiments of the present disclosure provide methods for creating a personal Internet of Things network (PIN), communication devices and storage media. A method is performed by a core network element. The method includes: receiving request information sent by an application function (AF), where the request information is configured to request to create the PIN.

### CROSS REFERENCE TO RELATED APPLICATIONS

The present application is a U.S. national phase of International Application No. PCT/CN2022/083806, filed on Mar. 29, 2022, the disclosure of which is incorporated herein by reference in its entirety for all purposes.

### TECHNICAL FIELD

The present disclosure relates to but is not limited to the field of wireless communication technologies, and in particular to methods for creating a personal IoT network (PIN), communication devices, and storage media.

### BACKGROUND

A personal Internet of Things (IOT) network (PIN) consists of PIN elements that communicate using a PIN direct connection or a direct network connection, and is managed locally (using one or more PIN elements with a management capability). Examples of PINs include networks of wearables, smart homes, and/or smart office equipment. Via a PIN element with a gateway capability, PIN elements have access to network services and can communicate with PIN elements that are not within range to use the PIN direct connection. A PIN includes at least one PIN element with gateway capability (PEGC) and at least one PIN element with management capability (PEMC). In related technologies, how to create a PIN is not given a solution.

### SUMMARY

The embodiments of the present disclosure disclose methods for creating a personal IoT network (PIN), communication devices, and storage media.

According to a first aspect of the embodiments of the present disclosure, there is provided a method for creating a PIN, performed by a core network element. The method includes: receiving request information sent by an application function (AF); where the request information is configured to request to create the PIN.

According to a second aspect of the embodiments of the present disclosure, there is provided a method for creating a personal IoT network (PIN), performed by an application function (AF). The method includes: sending request information to a core network element; where the request information is configured to request to create the PIN.

According to a third aspect of the embodiments of the present disclosure, there is provided a method for creating a personal IoT network (PIN), performed by a terminal. The method includes: receiving PIN information sent by a core network element, where the PIN information includes PIN information included in request information and/or information of PIN parameters generated by the core network element.

According to a fourth aspect of the embodiments of the present disclosure, there is provided a communication device. The communication device includes: one or more processors; and a memory configured to store instructions executable by the one or more processors.

The processor is configured to implement the method described in any embodiment of the present disclosure when running the instructions.

According to a fifth aspect of the embodiments of the present disclosure, there is provided a computer storage medium, which stores a computer executable program. When the executable program is executed by a processor, the method described in any embodiment of the present disclosure is implemented.

### BRIEF DESCRIPTION OF THE DRAWINGS

FIG. 1 is a schematic structural diagram of a wireless communication system according to an exemplary embodiment.

FIG. 2 is a flowchart of a method for creating a PIN according to an exemplary embodiment.

FIG. 3 is a flowchart of a method for creating a PIN according to an exemplary embodiment.

FIG. 4 is a flowchart of a method for creating a PIN according to an exemplary embodiment.

FIG. 5 is a flowchart of a method for creating a PIN according to an exemplary embodiment.

FIG. 6 is a flowchart of a method for creating a PIN according to an exemplary embodiment.

FIG. 7 is a flowchart of a method for creating a PIN according to an exemplary embodiment.

FIG. 8 is a flowchart of a method for creating a PIN according to an exemplary embodiment.

FIG. 9 is a flowchart of a method for creating a PIN according to an exemplary embodiment.

FIG. 10 is a flowchart of a method for creating a PIN according to an exemplary embodiment.

FIG. 11 is a flowchart of a method for creating a PIN according to an exemplary embodiment.

FIG. 12 is a flowchart of a method for creating a PIN according to an exemplary embodiment.

FIG. 13 is a flowchart of a method for creating a PIN according to an exemplary embodiment.

FIG. 14 is a flowchart of a method for creating a PIN according to an exemplary embodiment.

FIG. 15 is a schematic diagram of an apparatus for creating a PIN according to an exemplary embodiment.

FIG. 16 is a schematic diagram of an apparatus for creating a PIN according to an exemplary embodiment.

FIG. 17 is a schematic diagram of an apparatus for creating a PIN according to an exemplary embodiment.

FIG. 18 is a schematic structural diagram of a terminal according to an exemplary embodiment.

FIG. 19 is a block diagram of a base station according to an exemplary embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, etc. may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

For the purpose of brevity and ease of understanding, the term “greater than” or “less than” is used herein when characterizing the relationship of magnitudes. However, for those skilled in the art, it can be understood that the term “greater than” also covers the meaning of “greater than or equal to”, and the term “less than” also covers the meaning of “less than or equal to”.

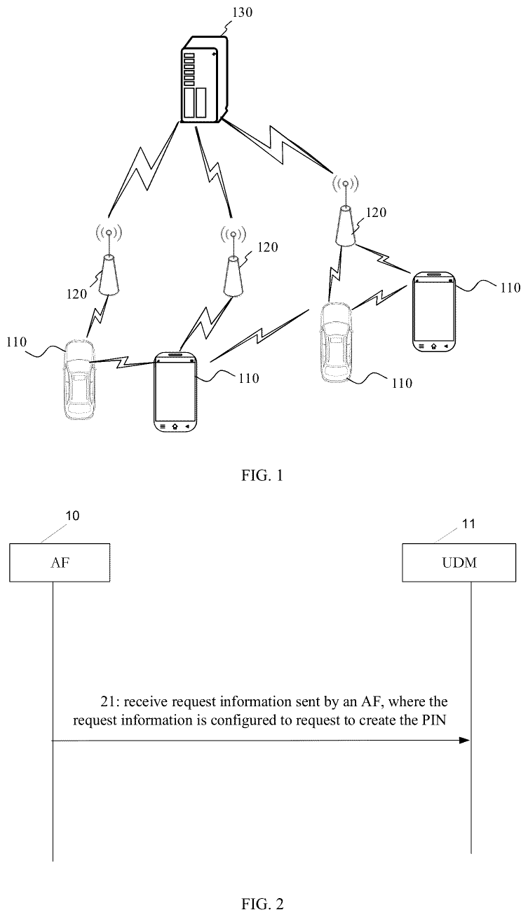

Referring to FIG. 1, FIG. 1 is a schematic structural diagram showing a wireless communication system provided in an embodiment of the present disclosure. As shown in FIG. 1, the wireless communication system is a communication system based on mobile communication technology, and may include several user equipment (UEs) 110 and several base stations 120.

The UE 110 may be a device that provides voice and/or data connectivity to a user. The UE 110 may communicate with one or more core networks via a radio access network (RAN). The UE 110 may be an Internet of Things UE, such as a sensor device, a mobile phone (or a “cellular” phone) and a computer with an Internet of Things UE. For example, the UE 110 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment (UE). Or, the UE 110 may be a device of an unmanned aerial vehicle. Or, the UE 110 may be a vehicle-mounted device, for example, a driving computer with a wireless communication function, or a wireless communication device externally connected with a driving computer. Or, the UE 110 may be a roadside device, such as a street lamp, a signal lamp or other roadside devices with a wireless communication function.

The base station 120 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN).

The base station 120 may be an evolved base station (eNB) used in the 4G system. Or, the base station 120 may be a centralized distributed architecture base station (gNB) used in the 5G system. When the base station 120 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 120 is not limited in the embodiments of the present disclosure.

A wireless connection may be established between the base station 120 and the UE 110 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between UEs 110, for example, a vehicle to vehicle (V2V) communication, a vehicle to infrastructure (V2I) communication and a vehicle to pedestrian (V2P) communication in a vehicle to everything (V2X) communication.

Herein, the above-mentioned UE can be considered as the terminal of the following embodiments.

In some embodiments, the above wireless communication system may further include a network management device 130.

Several base stations 120 are connected to the network management device 130, respectively. The network management device 130 may be a core network device in the wireless communication system. For example, the network management device 130 may be a mobility management entity (MME) in an evolved packet core (EPC). Or, the network management device can also be other core network device, for example, a serving gateway (SGW), a public data network gateway (PGW), a policy and charging rules function (PCRF) or a home subscriber server (HSS), etc. The implementation form of the network management device 130 is not limited in the embodiments of the present disclosure.

In order to facilitate those skilled in the art to understand, the embodiments of the present disclosure enumerate implementation manners to clearly illustrate the technical solutions of the embodiments of the present disclosure. Of course, those skilled in the art can understand that the embodiments provided in the present disclosure can be executed independently, or can be combined with the methods of other embodiments of the present disclosure to be executed together, or can be executed together with some methods in other related technologies after being executed alone or being combined, which is limited in the embodiments of the present disclosure.

In order to better understand the technical solution described in any embodiment of the present disclosure, application scenarios in related technologies are described firstly.

In an embodiment, management of PIN elements and PIN includes management of different types of PIN elements and configuration of PIN. A PIN element with management capability (PEMC) such as a network operators and authorized 3rd party can create and configure a PIN and PIN elements. After creating a PIN, the PEMC can add a PIN element with gateway capability (PEGC) into the PIN or remove a PEGC from the PIN, as well as add a PIN element into the PIN and associate the PIN element with some PEGCs that have already been added into the PIN, or remove a PIN element from the PIN.

The key issue is to study the following aspects in the fifth generation mobile communication (5G).
1. How to support mechanisms for a network operator or authorized 3^{rd} party (e.g., a PEMC) for PIN management, e.g., create/modify/delete/activate/deactivate a PIN, etc.
2. How to support for the management of PIN elements, including add/remove the PIN elements, as well as the association between PEGC and other PIN elements.
3. How to support establishing and enforcing a validity duration and time validity of a PIN (e.g., the PIN is valid for 30 minutes, the PIN is valid from 15:00 to 23:00) and a validity duration and time validity of PIN elements in a PIN (e.g., a PIN element (PINE) will be a member of a PIN for 1 hour, the PIN element will be the member of the PIN from 16:00 to 17:00).

It should be noted that the PIN element can also be understood as a PIN member of the PIN.

As shown in FIG. 2, this embodiment provides a method for creating a PIN, performed by a core network element. The method includes step 21.

In step 21, request information sent by an application function 10 (AF) is received by a UDM 11.

The request information is configured to request to create the PIN.

A terminal involved in the present disclosure may be, but is not limited to, a mobile phone, a wearable device, a vehicle-mounted terminal, a road side unit (a RSU), a smart home terminal, an industrial sensing device, and/or a medical device, etc. In some embodiments, the terminal may be a Redcap terminal or a predetermined version of a new radio (NR) terminal (e.g., a R17 NR terminal).

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network element involved in the present disclosure may be an access control and mobility management function (AMF), a network exposure function (NEF) and a unified data management (UDM), etc. It should be noted that the network element is not limited to the above examples, and can also be any network element with the capability to create a PIN. In some embodiments of the present disclosure, the network element with the capability to create a PIN can be deployed separately as a communication node or uniformly deployed in existing network elements. In summary, the network element with the capability to create a PIN can be understood as a logical node that can be flexibly deployed in a network, and is not limited herein.

In an embodiment, the core network element may be a UDM.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN.

It should be noted that the AF can be authorized in advance to create a PIN.

In a scenario embodiment, a user A needs to create a PIN on the N floor of a school. The user A can send indication information to the AF by using a mobile phone (a predetermined terminal) authorized by the AF. The indication information may include a name of a network to be created, one or more services provided by the network, service duration, and information of one or more PIN members. It should be noted that the indication information is not limited to the above information. After receiving the indication information, the AF sends request information to the UDM, where the request information is used to request to create a PIN. The request information may include the information included in the indication information. The UDM receives the request information sent by the AF. The UDM determines that the request information is received, and the UDM creates a PIN.

In an embodiment, the request information includes at least one of the following: a terminal identifier; attribute information of the PIN to be created; or information of one or more PIN elements (PINEs) included in the PIN to be created.

In an embodiment, the terminal identifier includes a universal external identifier. It should be noted that after successfully creating a PIN, the UDM will send PIN information to the terminal indicated by the terminal identifier.

In an embodiment, the attribute information of the PIN to be created includes at least one of the following: a PIN name (which is readable information for the user), one or more PIN services (services that the PINEs provided, e.g., printer, lamp, camera, etc.), and PIN validity time (used to define how long the PIN can work, e.g., 30 minutes).

In an embodiment, the information of the PIN elements included in the PIN to be created includes at least one of the following: PIN element identifiers (PINE IDs, unique IDs within a PIN that allocated by a PEMC), PINE types (indicating whether PINEs are PEMCs, PEGCs, or normal PINEs), service information (what the PINEs can provide, e.g., printer, or lamp, or camera, etc.), and PIN element names (human readable information, e.g., printer in bedroom, or lamp in living room).

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. Creating the PIN includes updating subscription data of the terminal, where updated subscription data includes data of PIN information included in the request information and/or data of PIN parameters generated by the core network element. When it is determined that the PIN is successfully created, the UDM will send PIN information to a target terminal. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. When it is determined that the PIN is successfully created, the UDM will send PIN information to a target terminal through a user parameter update (UPU) procedure or a UE configuration update (UCU) procedure. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN. When it is determined that the PIN is successfully created, the UDM sends a response message to create the PIN to the AF.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN. When it is determined that the PIN is successfully created, the UDM sends PIN information to the terminal, where the PIN information includes PIN information included in the request information and information of PIN parameters generated by the core network element. The UDM receives a feedback message sent by the terminal. When it is determined that the received feedback message indicates that the PIN information is received, the UDM sends a response message to create the PIN to the AF.

In the embodiment of the present disclosure, the request information sent by the AF is received, where the request information is configured to request to create a PIN. Here, after receiving the request information sent by the AF, the core network element can create a PIN based on the request information. Compared with the situation where a PIN cannot be created based on the request, the embodiment can adapt to requirements of creating a PIN, flexibly create a PIN, provide services to users, and satisfy application requirements in various scenarios.

It should be noted that those skilled in the art can understand that the methods provided in the embodiments of the present disclosure can be performed separately or together with some methods in the embodiments of the present disclosure or related technologies.

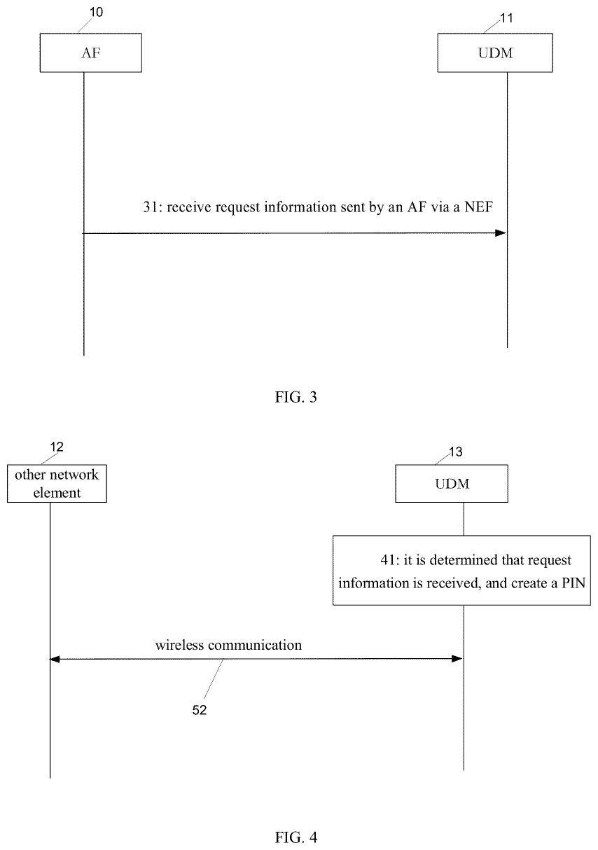

As shown in FIG. 3, this embodiment provides a method for creating a PIN, performed by a core network element. The method includes step 31.

In step 31, request information sent by an AF 10 is received via a network exposure function (NEF).

In an embodiment, an AF is triggered by an authorized predetermined terminal to create a PIN. The AF sends request information to a UDM 11 through a NEF, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. The UDM will also send a response message for the requested information to the AF. For example, it is determined that the PIN is successfully created, and a response message accepting the request information is sent to the AF; or, it is determined that the PIN is not successfully created, and a response message rejecting the request information is sent to the AF.

It should be noted that those skilled in the art can understand that the methods provided in the embodiments of the present disclosure can be performed separately or together with some methods in the embodiments of the present disclosure or related technologies.

As shown in FIG. 4, this embodiment provides a method for creating a PIN, performed by a core network element 12. The method includes step 41.

In step 41, it is determined that request information is received, and a PIN is created.

In an embodiment, an AF is triggered by an authorized predetermined terminal to create a PIN. The AF sends request information to a UDM 13, where the request information is used to request to create a PIN. The UDM receives the request information sent by the AF; determines that the request information is received, and the UDM creates a PIN. Creating the PIN includes updating subscription data of the terminal, where updated subscription data includes data of PIN information included in the request information and/or data of PIN parameters generated by the core network element. When it is determined that the PIN is successfully created, the UDM will send PIN information to a target terminal. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

It should be noted that those skilled in the art can understand that the methods provided in the embodiments of the present disclosure can be performed separately or together with some methods in the embodiments of the present disclosure or related technologies.

As shown in FIG. 5, this embodiment provides a method for creating a PIN, performed by a core network element 12. The method includes step 51.

In step 51, subscription data of a terminal is updated by a UDM 13, where updated subscription data includes data of PIN information included in the request information and/or data of PIN parameters generated by the core network element. Communication 52 between the UDM and the core network element is also shown.

Here, the data of the PIN parameters generated by the network element can be network parameters of the created PIN, for example, latency and service quality.

For the description of step 51, please refer to step 41 in detail, which is not repeated here.

It should be noted that those skilled in the art can understand that the methods provided in the embodiments of the present disclosure can be performed separately or together with some methods in the embodiments of the present disclosure or related technologies.

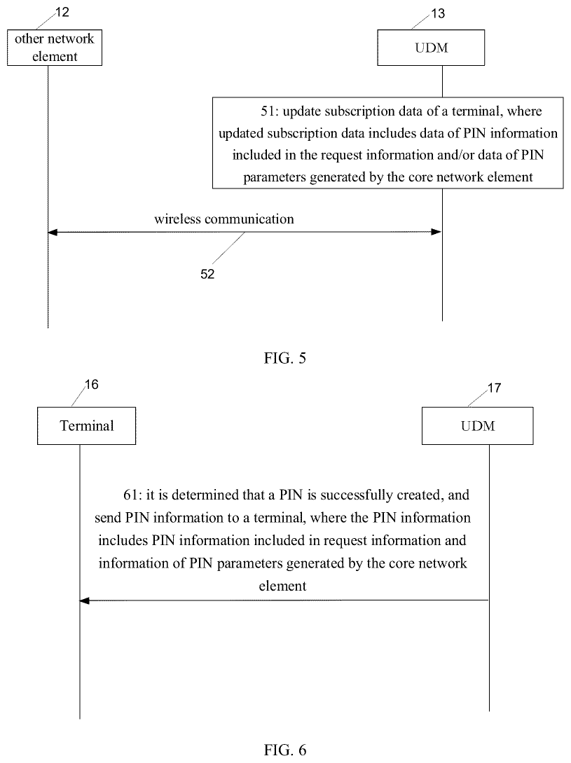

As shown in FIG. 6, this embodiment provides a method for creating a PIN, performed by a core network element. The method includes step 61.

In step 61, it is determined that a PIN is successfully created, and PIN information is sent by a UDM 15 to a terminal 14, where the PIN information includes PIN information included in request information and information of PIN parameters generated by the core network element.

In an embodiment, it is determined that the PIN is successfully created, and the PIN information is sent to the terminal, where the PIN information includes the PIN information included in the request information and the information of the PIN parameters generated by the core network element. A feedback message sent by the terminal is received. It is determined that the received feedback message indicates that the PIN information is received, and a response message accepting the request information is sent to the AF. Or, it is determined that the received feedback message indicates that the PIN information is not received, and a response message rejecting the request information is sent to the AF.

It should be noted that those skilled in the art can understand that the methods provided in the embodiments of the present disclosure can be performed separately or together with some methods in the embodiments of the present disclosure or related technologies.

As shown in FIG. 7, this embodiment provides a method for creating a PIN, performed by a core network element. The method includes step 71.

In step 71, PIN information is sent by a UDM 15 to a terminal 14, where the PIN information includes that the terminal is capable of being configured as a PIN element (PINE), a PIN element with management capability (PEMC), and/or a PIN element with gateway capability (PEGC).

In this way, after receiving the PIN information, the terminal can determine that the terminal is configured as a PINE, a PEMC, and/or a PEGC, and the terminal can execute corresponding functions.

It should be noted that those skilled in the art can understand that the methods provided in the embodiments of the present disclosure can be performed separately or together with some methods in the embodiments of the present disclosure or related technologies.

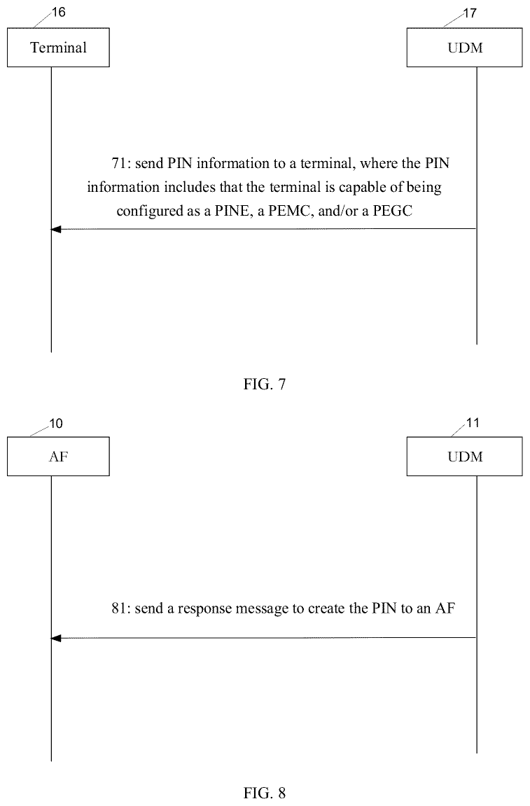

As shown in FIG. 8, this embodiment provides a method for creating a PIN, performed by a core network element. The method includes step 81.

In step 81, a response message to create the PIN is sent to an AF 10.

In an embodiment, the AF is triggered by an authorized predetermined terminal to create a PIN. The AF sends request information to a UDM11 through a NEF, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. The UDM will also send a response message for the requested information to the AF through a NEF. For example, it is determined that the PIN is successfully created, and a response message accepting the request information is sent to the AF; or, it is determined that the PIN is not successfully created, and a response message rejecting the request information is sent to the AF; or, it is determined that the received feedback message indicates that the PIN information is received, and a response message accepting the request information is sent to the AF; or it is determined that the received feedback message indicates that the PIN information is not received, and a response message rejecting the request information is sent to the AF.

It should be noted that those skilled in the art can understand that the methods provided in the embodiments of the present disclosure can be performed separately or together with some methods in the embodiments of the present disclosure or related technologies.

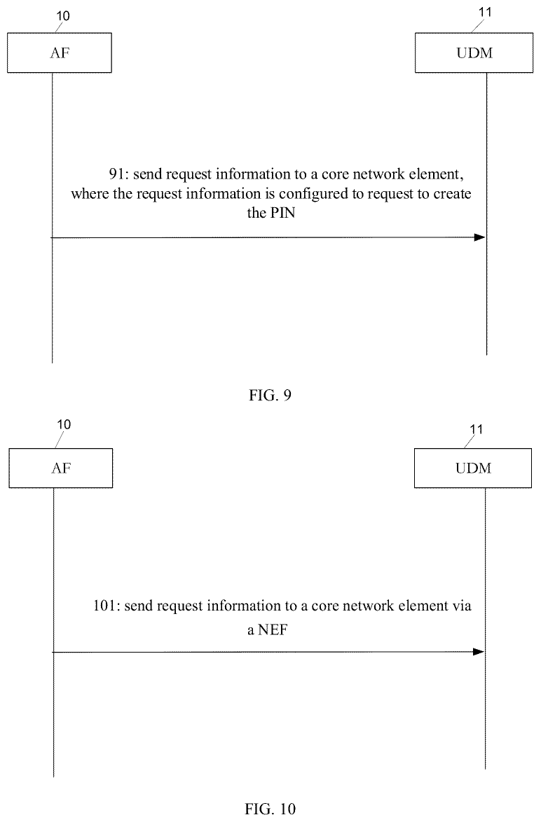

As shown in FIG. 9, this embodiment provides a method for creating a PIN, performed by an application function 10 (AF). The method includes step 91.

In step 91, request information is sent to a core network element.

where the request information is configured to request to create the PIN.

A terminal involved in the present disclosure may be, but is not limited to, a mobile phone, a wearable device, a vehicle-mounted terminal, a road side unit (a RSU), a smart home terminal, an industrial sensing device, and/or a medical device, etc. In some embodiments, the terminal may be a Redcap terminal or a predetermined version of a new radio (NR) terminal (e.g., a R17 NR terminal).

A base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network element involved in the present disclosure may be an access control and mobility management function (AMF), a network exposure function (NEF) and a unified data management 11 (UDM), etc. It should be noted that the network element is not limited to the above examples, and can also be any network element with the capability to create a PIN. In some embodiments of the present disclosure, the network element with the capability to create a PIN can be deployed separately as a communication node or uniformly deployed in existing network elements. In summary, the network element with the capability to create a PIN can be understood as a logical node that can be flexibly deployed in a network, and is not limited herein. In an embodiment, the core network element may be a UDM.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN.

It should be noted that the AF can be authorized in advance to create a PIN.

In a scenario embodiment, a user A needs to create a PIN on the N floor of a school. The user A can send indication information to the AF by using a mobile phone (a predetermined terminal) authorized by the AF. The indication information may include a name of a network to be created, one or more services provided by the network, service duration, and information of one or more PIN members. It should be noted that the indication information is not limited to the above information. After receiving the indication information, the AF sends request information to the UDM, where the request information is used to request to create a PIN. The request information may include the information included in the indication information. The UDM receives the request information sent by the AF. The UDM determines that the request information is received, and the UDM creates a PIN.

In an embodiment, the request information includes at least one of the following: a terminal identifier; attribute information of the PIN to be created; or information of one or more PIN elements (PINEs) included in the PIN to be created.

In an embodiment, the terminal identifier includes a universal external identifier. It should be noted that after successfully creating a PIN, the UDM will send PIN information to the terminal indicated by the terminal identifier.

In an embodiment, the attribute information of the PIN to be created includes at least one of the following: a PIN name (which is readable information for the user), one or more PIN services (services that the PINEs provided, e.g., printer, lamp, camera, etc.), and PIN validity time (used to define how long the PIN can work, e.g., 30 minutes).

In an embodiment, the information of the PIN elements included in the PIN to be created includes at least one of the following: PIN element identifiers (PINE IDs, unique IDs within a PIN that allocated by a PEMC), PINE types (indicating whether PINEs are PEMCs, PEGCs, or normal PINEs), service information (what the PINEs can provide, e.g., printer, or lamp, or camera, etc.), and PIN element names (human readable information, e.g., printer in bedroom, or lamp in living room).

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. Creating the PIN includes updating subscription data of the terminal, where updated subscription data includes data of PIN information included in the request information and/or data of PIN parameters generated by the core network element. When it is determined that the PIN is successfully created, the UDM will send PIN information to a target terminal. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. When it is determined that the PIN is successfully created, the UDM will send PIN information to a target terminal through a user parameter update (UPU) procedure or a UE configuration update (UCU) procedure. The PIN information includes PIN information included in the request information and information of PIN parameters generated by the UDM. Here, the target terminal may be a terminal that can act as a PEMC predetermined by the AF, for example, the AF may determine an identity ID of the target terminal in advance.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN. When it is determined that the PIN is successfully created, the UDM sends a response message to create the PIN to the AF.

In an embodiment, the AF is triggered by an authorized predetermined terminal to create a PIN. The AF sends request information to the UDM through a NEF, where the request information is used to request to create a PIN. The UDM receives the request information sent by the AF; determines that the request information is received, and the UDM creates a PIN. When it is determined that the PIN is successfully created, the UDM sends PIN information to the terminal, where the PIN information includes PIN information included in the request information and information of PIN parameters generated by the core network element. The UDM receives a feedback message sent by the terminal. When it is determined that the received feedback message indicates that the PIN information is received, the UDM sends a response message to create the PIN to the AF.

It should be noted that those skilled in the art can understand that the methods provided in the embodiments of the present disclosure can be performed separately or together with some methods in the embodiments of the present disclosure or related technologies.

As shown in FIG. 10, this embodiment provides a method for creating a PIN, performed by an AF. The method includes step 101.

In step 101, request information is sent to a core network element via a NEF.

In an embodiment, the AF 10 is triggered by an authorized predetermined terminal to create a PIN. The AF sends request information to a UDM 11 through a NEF, where the request information is used to request to create a PIN. The UDM receives the request information sent by the AF; determines that the request information is received, and the UDM creates a PIN.

It should be noted that those skilled in the art can understand that the methods provided in the embodiments of the present disclosure can be performed separately or together with some methods in the embodiments of the present disclosure or related technologies.

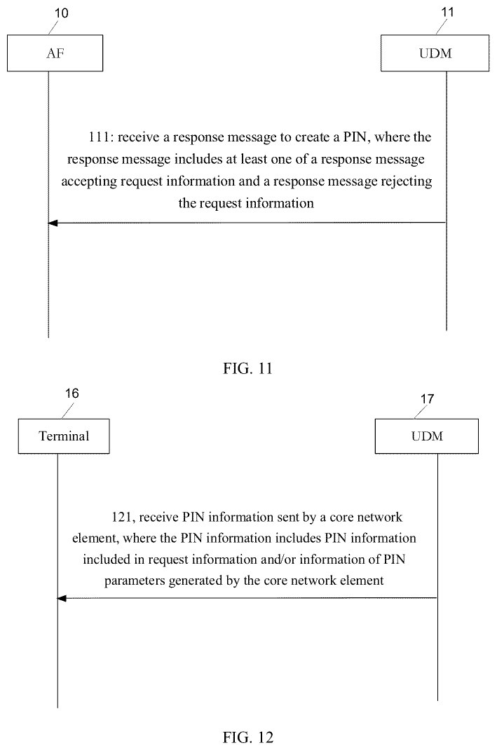

As shown in FIG. 11, this embodiment provides a method for creating a PIN, performed by an AF. The method includes step 111.

In step 111, a response message to create a PIN is received, where the response message includes at least one of a response message accepting request information and a response message rejecting the request information.

In an embodiment, the response message to create the PIN is received via a NEF.

In an embodiment, the AF 10 is triggered by an authorized predetermined terminal to create a PIN. The AF sends request information to a UDM 11 through a NEF, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. The UDM will also send a response message for the requested information to the AF through a NEF. For example, it is determined that the PIN is successfully created, and a response message accepting the request information is sent to the AF; or, it is determined that the PIN is not successfully created, and a response message rejecting the request information is sent to the AF; or, it is determined that the received feedback message indicates that the PIN information is received, and a response message accepting the request information is sent to the AF; or it is determined that the received feedback message indicates that the PIN information is not received, and a response message rejecting the request information is sent to the AF.

It should be noted that those skilled in the art can understand that the methods provided in the embodiments of the present disclosure can be performed separately or together with some methods in the embodiments of the present disclosure or related technologies.

As shown in FIG. 12, this embodiment provides a method for creating a PIN, performed by a terminal. The method includes step 121.

In step 121, PIN information sent by a core network element is received, where the PIN information includes PIN information included in request information and/or information of PIN parameters generated by the core network element.

In an embodiment, the request information includes at least one of the following: a terminal identifier; attribute information of a PIN to be created; or information of one or more PIN elements (PINEs) included in the PIN to be created.

In an embodiment, the terminal identifier includes a universal external identifier. It should be noted that after successfully creating a PIN, a UDM will send PIN information to a terminal indicated by the terminal identifier.

In an embodiment, the attribute information of the PIN to be created includes at least one of the following: a PIN name (which is readable information for a user), one or more PIN services (services that the PINEs provided, e.g., printer, lamp, camera, etc.), and PIN validity time (used to define how long the PIN can work, e.g., 30 minutes).

In an embodiment, the information of the PIN elements included in the PIN to be created includes at least one of the following: PIN element identifiers (PINE IDs, unique IDs within a PIN that allocated by a PEMC), PINE types (indicating whether PINEs are PEMCs, PEGCs, or normal PINEs), service information (what the PINEs can provide, e.g., printer, or lamp, or camera, etc.), and PIN element names (human readable information, e.g., printer in bedroom, or lamp in living room).

In an embodiment, an AF is triggered by an authorized predetermined terminal to create a PIN. The AF sends request information to the UDM, where the request information is used to request to create a PIN. The UDM receives the request information sent by the AF; determines that the request information is received, and the UDM creates a PIN. Creating the PIN includes updating subscription data of the terminal, where updated subscription data includes data of PIN information included in the request information and/or data of PIN parameters generated by the core network element. When it is determined that the PIN is successfully created, the UDM will send PIN information to a terminal. The PIN information includes PIN information included in the request information and information of PIN parameters generated by the UDM. Here, the terminal may be a terminal that can act as a PEMC predetermined by the AF, for example, the AF may determine an identity ID of the terminal in advance.

In an embodiment, the PIN information includes that the terminal is capable of being configured as a PIN element (PINE), a PIN element with management capability (PEMC), and/or a PIN element with gateway capability (PEGC).

In this way, after receiving the PIN information, the terminal can determine that the terminal is configured as a PINE, a PEMC, and/or a PEGC, and the terminal can execute corresponding functions.

It should be noted that those skilled in the art can understand that the methods provided in the embodiments of the present disclosure can be performed separately or together with some methods in the embodiments of the present disclosure or related technologies.

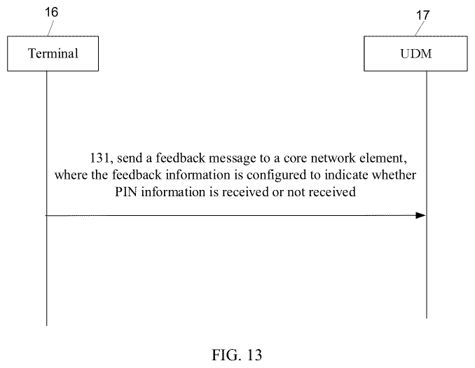

As shown in FIG. 13, this embodiment provides a method for creating a PIN, performed by a terminal 16. The method includes step 131.

In step 131, a feedback message is sent to a core network element 17, where the feedback information is configured to indicate whether PIN information is received or not received.

In an embodiment, an AF is triggered by an authorized predetermined terminal to create a PIN. The AF sends request information to a UDM through a NEF, where the request information is used to request to create a PIN. The UDM receives the request information sent by the AF; determines that the request information is received, and the UDM creates a PIN. When it is determined that the PIN is successfully created, the UDM will send PIN information to a target terminal. The PIN information includes PIN information included in the request information and information of PIN parameters generated by the UDM. The UDM will also send a response message for the requested information to the AF through a NEF. For example, it is determined that a received feedback message indicates that the PIN information is received, and a response message accepting the request information is sent to the AF; or it is determined that the received feedback message indicates that the PIN information is not received, and a response message rejecting the request information is sent to the AF

It should be noted that those skilled in the art can understand that the methods provided in the embodiments of the present disclosure can be performed separately or together with some methods in the embodiments of the present disclosure or related technologies.

In order to better understand the embodiments of the present disclosure, the technical solution of the present disclosure will be further explained by an exemplary embodiment.

### Example 1

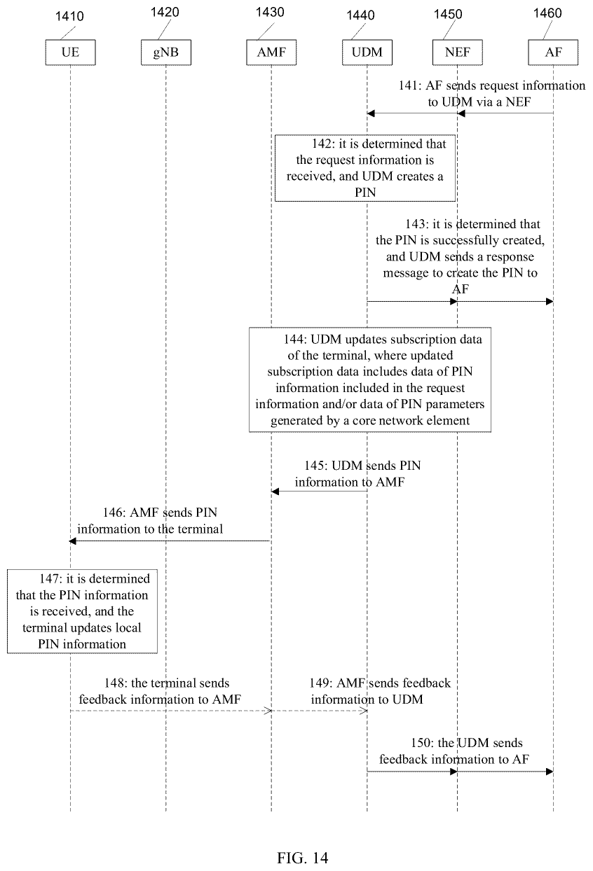

As shown in FIG. 14, this embodiment provides a method for creating a PIN, performed by a terminal. The method includes steps 141 to 150.

In step 141, an AF 1460 sends request information (PIN create request [UE ID, PIN info {PIN name, PIN services, PINE list {}) to a UDM 1440 via a NEF 1450, where the request information is used to request to create a PIN. The request information can include a name of a network to be created, one or more services provided by the network, service duration, and information of one or more PIN members.

In step 142, it is determined that the request information is received, and the UDM creates a PIN.

In step 143, it is determined that the PIN is successfully created, and the UDM sends a response message (PIN create response [result, optional {PIN info}]) to create the PIN to the AF.

In step 144, the UDM updates subscription data of the terminal, where updated subscription data includes data of PIN information included in the request information and/or data of PIN parameters generated by a core network element.

In step 145, the UDM sends PIN information (Nudm_SDM Notification [PIN info {PIN ID, PIN name, PINE list {}]) to an AMF 1430, where the PIN information includes PIN information included in the request information and information of PIN parameters generated by the core network element.

In step 146, the AMF sends PIN information (DL NAS TRANSPORT [UPU container {PIN info}]) to the terminal 1410. The PIN information may be sent to the terminal 1410 via gNB 1420.

In step 147, it is determined that the PIN information is received, and the terminal updates local PIN information.

In step 148, the terminal sends feedback information (UL NAS TRANSPORT [UPU ACK]) to the AMF.

In step 149, the AMF sends feedback information (Nudm_SDM_Info) to the UDM.

In step 150, the UDM sends feedback information (PIN create response [result, optional {PIN info}]) to the AF.

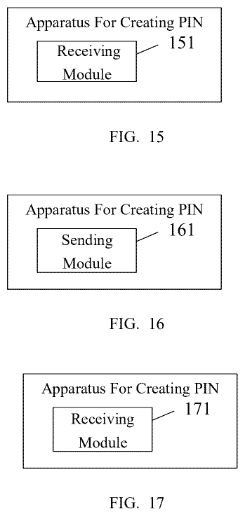

As shown in FIG. 15, this embodiment provides an apparatus for creating a PIN. The apparatus includes a receiving module 151.

The receiving module 151 is configured to receive request information sent by an application function (AF).

The request information is configured to request to create a PIN.

It should be noted that those skilled in the art can understand that the methods provided in the embodiments of the present disclosure can be performed separately or together with some methods in the embodiments of the present disclosure or related technologies.

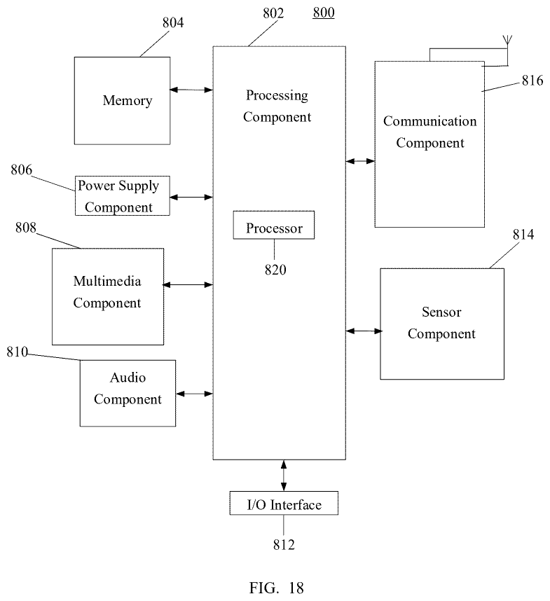

As shown in FIG. 16, this embodiment provides an apparatus for creating a PIN. The apparatus includes a sending module 161.

The sending module 161 is configured to send request information to a core network element.

The request information is configured to request to create a PIN.

It should be noted that those skilled in the art can understand that the methods provided in the embodiments of the present disclosure can be performed separately or together with some methods in the embodiments of the present disclosure or related technologies.

As shown in FIG. 17, this embodiment provides an apparatus for creating a PIN. The apparatus includes a receiving module 171.

The receiving module 171 is configured to receive PIN information sent by a core network element, where the PIN information includes PIN information included in request information and/or information of PIN parameters generated by the core network element.

It should be noted that those skilled in the art can understand that the methods provided in the embodiments of the present disclosure can be performed separately or together with some methods in the embodiments of the present disclosure or related technologies.

An embodiment of the present disclosure provides a communication device including: one or more processors; and a memory configured to store instructions executable by the one or more processors.

The processor is configured to implement the method applied to any embodiment of the present disclosure when running the instructions.

The processors may include various types of storage media, which are non-transitory computer storage media that can continue to remember information stored on the communication device after power failure.

The processors can be connected to the memory through a bus or the like to read executable programs stored on the memory.

An embodiment of the present disclosure also provides a computer storage medium. The computer storage medium stores a computer executable program, and the executable program, when executed by a processor, implements the method in any embodiment of the present disclosure.

Regarding the apparatuses in the above embodiments, the specific manner in which each module performs operations have been described in detail in the relevant method embodiments, and will not be elaborated here.

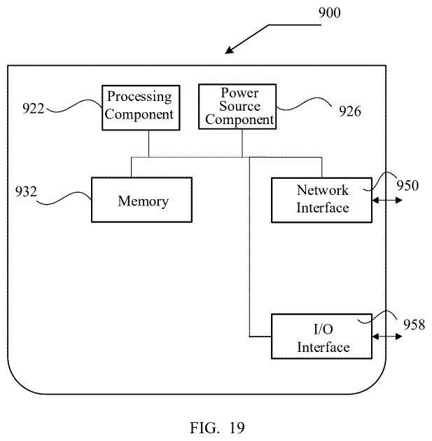

As shown in FIG. 18, an embodiment of the present disclosure provides a structure of a terminal.

As shown in FIG. 18, this embodiment provides a terminal 800. The terminal 800 can specifically be a mobile phone, a computer, a digital broadcasting terminal, a messaging device, a game console, a tablet device, a medical device, a fitness device, a personal digital assistant, and the like.

Referring to FIG. 18, the terminal 800 can include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the terminal 800, such as operations associated with display, phone calls, data communication, camera operations, and recording operations. The processing component 802 can include one or more processors 820 to execute instructions to complete all or part of the steps of the above methods. In addition, the processing component 802 can include one or more modules which facilitate the interaction between the processing component 802 and other components. For example, the processing component 802 can include a multimedia module to facilitate the interaction between the multimedia component 808 and the processing component 802.

The memory 804 is configured to store various types of data to support the operation of the terminal 800. Examples of such data include instructions for any application or method operated on the terminal 800, contact data, phonebook data, messages, pictures, videos, and so on. The memory 804 can be implemented by any type of volatile or non-volatile storage devices or a combination thereof, such as a Static Random Access Memory (SRAM), an Electrically Erasable Programmable Read Only Memory (EEPROM), an Erasable Programmable Read Only Memory (EPROM), a Programmable Read Only memory (PROM), a Read Only Memory (ROM), a magnetic memory, a flash memory, a magnetic or an optical disk.

The power supply component 806 provides power to various components of the terminal 800. The power supply component 806 can include a power management system, one or more power supplies, and other components associated with generating, managing, and distributing power for the terminal 800.

The multimedia component 808 includes a screen providing an output interface between the terminal 800 and a user. In some examples, the screen may include a liquid crystal display (LCD) and a touch panel (TP). If the screen includes the TP, the screen can be implemented as a touch screen to receive input signals from the user. The TP includes one or more touch sensors to sense touches, swipes, and gestures on the TP. The touch sensor can not only sense a boundary of a touch or swipe, but also sense a lasting time and a pressure associated with the touch or swipe. In some embodiments, the multimedia component 808 can include a front camera and/or a rear camera. The front camera and/or rear camera can receive external multimedia data when the terminal 800 is in an operating mode, such as a photographing mode or a video mode. Each of the front camera and the rear camera can be a fixed optical lens system or have focal length and optical zooming capability.

The audio component 810 is configured to output and/or input an audio signal. For example, the audio component 810 includes a microphone (MIC). When the terminal 800 is in an operating mode, such as a call mode, a recording mode, and a voice recognition mode, the MIC is configured to receive an external audio signal. The received audio signal may be further stored in the memory 804 or transmitted via the communication component 816. In some embodiments, the audio component 810 further includes a speaker to output an audio signal.

The I/O interface 812 can provide an interface between the processing component 802 and peripheral interface modules. The above peripheral interface modules can include a keyboard, a click wheel, buttons and so on. These buttons can include, but are not limited to, a home button, a volume button, a starting button and a locking button.

The sensor component 814 includes one or more sensors to provide status assessments of various aspects for the terminal 800. For example, the sensor component 814 can detect the on/off status of the terminal 800, and relative positioning of a component, for example, the component is a display and a keypad of the terminal 800. The sensor component 814 may also detect a change in position of the terminal 800 or a component of the terminal 800, a presence or absence of the contact between a user and the terminal 800, an orientation or an acceleration/deceleration of the terminal 800, and a change in temperature of the terminal 800. The sensor component 814 can include a proximity sensor configured to detect the presence of a nearby object without any physical contact. The sensor component 814 can further include an optical sensor, such as a Complementary Metal Oxide Semiconductor (CMOS) or Charge-coupled Device (CCD) image sensor which is used in imaging applications. In some embodiments, the sensor component 814 can further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network that is based on communication standards, such as Wi-Fi, 2G, 3G, or a combination thereof. In an exemplary embodiment, the communication component 816 receives a broadcast signal or broadcast-associated information from an external broadcast management system via a broadcast channel. In an exemplary embodiment, the communication component 816 further includes a Near Field Communication (NFC) module to facilitate short-range paging. For example, the NFC module can be implemented based on a Radio Frequency Identification (RFID) technology, an Infrared Data Association (IrDA) technology, an Ultra-Wide Band (UWB) technology, a Blue Tooth (BT) technology and other technologies.

In an exemplary embodiment, the terminal 800 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the above methods.

In an exemplary embodiment, there is also provided a non-transitory machine readable storage medium including instructions, such as the memory 804 including instructions. The instructions may be executed by the processor 820 of the terminal 800 to perform the above methods. For example, the non-transitory machine readable storage medium can be a ROM, a Random Access Memory (RAM), a CD-ROM, a magnetic tape, a floppy disk, an optical data storage device, and the like.

As shown in FIG. 19, an embodiment of the present disclosure illustrates the structure of a base station. For example, the base station 900 can be provided as a network side device. Referring to FIG. 19, the base station 900 includes a processing component 922 which further includes one or more processors, and a memory resource represented by a memory 932, configured to store instructions such as application programs executable by the processing component 922. The application programs stored in the memory 932 can include one or more than one modules, each of which corresponds to a set of instructions. In addition, the processing component 922 is configured to execute the instructions to perform any of the above methods applied to the base station.

The base station 900 can further include a power source component 926 configured to execute power management of the base station 900, a wired or wireless network interface 950 configured to connect the base station 900 to a network, and an I/O interface 958. The base station 900 can be operated on the basis of an operating system stored in the memory 932, such as Windows Server TM, Mac OS XTM, UnixTM, LinuxTM or FreeBSDTM.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the present disclosure is not limited to the precise structure that has been described above and shown in the drawings, and various modifications and changes may be made without departing from the scope thereof. The scope of the present disclosure is limited only by the appended claims.

1. A method for creating a personal loT network (PIN), performed by a core network element, the method comprising:
receiving request information sent by an application function (AF);
wherein the request information is configured to request to create the PIN.

2. The method according to claim 1, wherein the request information comprises at least one of:
a terminal identifier;
attribute information of the PIN to be created; or
information of one or more PIN elements comprised in the PIN to be created;
wherein the attribute information comprises at least one of: a PIN name; information of one or more PIN services; or PIN validity time; and
wherein the information of the one or more PIN elements comprises at least one of: PIN element identifiers; PIN element types; information of one or more PIN services; or PIN element names.

3.-4. (canceled)

5. The method according to claim 1, wherein receiving the request information sent by the AF comprises:
receiving the request information sent by the AF via a network exposure function (NEF).

6. The method according to claim 1, further comprising:
determining that the request information is received, and creating the PIN;
wherein creating the PIN comprises:
updating subscription data of a terminal, wherein updated subscription data comprises at least one of data of PIN information comprised in the request information or data of PIN parameters generated by the core network element.

7. (canceled)

8. The method according to claim 6, further comprising:
determining that the PIN is successfully created, and sending PIN information to a terminal, wherein the PIN information comprises at least one of PIN information comprised in the request information or information of PIN parameters generated by the core network element.

9. The method according to claim 8, wherein sending the PIN information to the terminal comprises:
sending the PIN information to the terminal through a user parameter update (UPU) procedure or a user equipment (UE) configuration update (UCU) procedure.

10. The method according to claim 8, wherein the PIN information comprises that the terminal is capable of being configured as at least one of a PIN element (PINE), a PIN element with management capability (PEMC), or a PIN element with gateway capability (PEGC).

11. The method according to claim 8, further comprising:
receiving a feedback message sent by the terminal.

12. The method according to claim 11, further comprising:
sending a response message to create the PIN to the AF;
wherein sending the response message to create the PIN to the AF comprises at least one of:
determining that the PIN is successfully created, and sending a response message accepting the request information to the AF;
determining that the PIN was not successfully created, and sending a response message rejecting the request information to the AF;
determining that the received feedback message indicates that the PIN information is received, and sending a response message accepting the request information to the AF;
determining that the received feedback message indicates that the PIN information is not received, and sending a response message rejecting the request information to the AF; or
sending the response message to create the PIN to the AF via a network exposure function (NEF).

13.-14. (canceled)

15. A method for creating a personal loT network (PIN), performed by an application function (AF), the method comprising:
sending request information to a core network element;
wherein the request information is configured to request to create the PIN.

16. The method according to claim 15, wherein the request information comprises at least one of:
a terminal identifier;
attribute information of the PIN to be created; or
information of one or more PIN elements comprised in the PIN to be created;
wherein the attribute information comprises at least one of: a PIN name; information of one or more PIN services; or PIN validity time; and
wherein the information of the one or more PIN elements comprises at least one of: PIN element identifiers; PIN element types; information of one or more PIN services; or PIN element names.

17.-18. (canceled)

19. The method according to claim 15, wherein sending the request information to the core network element comprises:
sending the request information to the core network element via a network exposure function (NEF).

20. The method according to claim 15, further comprising:
receiving a response message to create the PIN, wherein the response message comprises at least one of a response message accepting the request information or a response message rejecting the request information;
wherein receiving the response message to create the PIN comprises:
receiving the response message to create the PIN via a network exposure function (NEF).

21. (canceled)

22. A method for creating a personal loT network (PIN), performed by a terminal, the method comprising:
receiving PIN information sent by a core network element, wherein the PIN information comprises at least one of PIN information comprised in request information or information of PIN parameters generated by the core network element.

23. The method according to claim 22, wherein receiving the PIN information sent by the core network element comprises:
receiving the PIN information sent by the core network element through a user parameter update (UPU) procedure;
wherein the PIN information comprises that the terminal is capable of being configured as at least one of a PIN element (PINE), a PIN element with management capability (PEMC), or a PIN element with gateway capability (PEGC).

24. (canceled)

25. The method according to claim 22, further comprising:
sending a feedback message to the core network element, wherein the feedback information is configured to indicate whether the PIN information is received or not received.

26.-28. (canceled)

29. A communication device comprising:
a memory; and
one or more processors, connected to the memory, and configured to execute computer executable instructions stored on the memory to perform the method according to claim 1.

30. (canceled)

31. A communication device comprising:
a memory; and
one or more processors, connected to the memory, and configured to execute computer executable instructions stored on the memory to perform the method according to claim 15.

32. A communication device comprising:
a memory; and
one or more processors, connected to the memory, and configured to execute computer executable instructions stored on the memory to perform the method according to claim 22.
